(19) United States
(12) Patent Application Publication
(10) Pub. No.: US 2012/0044690 A1
(43) Pub. Date: Feb. 23, 2012

(54) EXPANDABLE PENDANT LAMP

(76) Inventor: TZU-YU HSUEH, Taoyuan City (TW)

(21) Appl. No.: 12/861,816

(22) Filed: Aug. 23, 2010

(51) Int. Cl. F21S 4/00

(52) U.S. Cl. 362/249.06; 362/249.16

(57) ABSTRACT

The expandable pendant lamp contains a number of lamp units, each having at least a light generation element. The lamp units are vertically stacked and any two adjacent lamp units are connected by a number of flexible linear elements. For each pair of adjacent lamp units, magnetic elements are configured along the interfacing faces of the lamp units, respectively so that magnetic attraction therebetween would pull the adjacent lamp units together. The expandable pendant lamp, as it is hung from a ceiling, could have its lamp units vertically stacked together or the lamp units are separated apart to hold various objects such as utensils and decorators.

### TECHNICAL FIELD OF THE INVENTION

The present invention generally relates to pendant lamps, and more particular to an expandable pendant lamp having multiple chained lamp units that could be vertically stacked together or separated apart.

### DESCRIPTION OF THE PRIOR ART

A conventional pendant lamp usually contains a lamp body hung from a ceiling by a string or a chain. When the pendant lamp is turned on, its light usually is radiated from a single point (i.e., the lamp body) and covers limited areas beneath and around the pendant lamp.

On the other hand, taking a dining table as example, people usually have various utensils, cruets, and other decorators on the tabletop. Usually there is no specific storage place for these items. It therefore occurs to the present inventor that it would rather convenient that a pendant lamp above the dining table could be expanded into several tiers and these tabletop items could be stored on these tiers. Additional advantages are that the expanded pendant lamp could also offer a much larger light coverage, and the tiers of the pendant lamp could be stacked together to save space.

### SUMMARY OF THE INVENTION

The expandable pendant lamp contains a number of lamp units, each having at least a light generation element. The lamp units are vertically stacked and any two adjacent lamp units are connected by a number of flexible linear elements. For each pair of adjacent lamp units, magnetic elements are configured along the interfacing faces of the lamp units, respectively so that magnetic attraction therebetween would pull the adjacent lamp units together. The expandable pendant lamp, as it is hung from a ceiling, could have its lamp units vertically stacked together or the lamp units are separated apart to hold various objects such as utensils and decorators.

The lamp units are appropriately shaped so that, when they are joined together as described above, the pedant lamp could have a spherical, rectangular, diamond, or conical shape, to mention just a few.

Each lamp unit contains a bottom plate and, along a top rim of the bottom plate, a flange wall is provided. The magnetic elements are embedded along a top side of the flange wall. The flange walls separate the lamp units and to create storage spaces.

The light generation elements could be installed on a top side or a bottom side of the bottom plate, or on an inner side of the flange wall, of each lamp unit. Each light generation element contains a number of light emitting diodes (LEDs) and a carrier board where the LEDs are installed.

Each lamp unit is made of a transparent material so that the light produced from the light generation elements could pass through. Alternatively, a layer of coating is applied to an area of the lamp unit so that the coated area is opaque and the un-coated area reveals a pattern. When the light generation elements are turned on, the pattern is vividly illuminated.

Each lamp unit has a through hole allowing an electrical cable to pass through and to reach the light generation elements on the lamp unit beneath.

Each flexible linear element has each of its ends running through a positioning screw and forming a locking head beyond the positioning screw. The positioning screws are fixed separately on two adjacent lamp units so that the two lamp units are reliably connected by the flexible linear elements. The flexible linear elements could be a rope, a chain, a steel string, etc.

A bottommost lamp unit could have a transparent bottom area so that the light could be projected downward.

The expandable pendant lamp has the following advantages. First, the lamp units could be joined together vertically to save space when hung from a ceiling. Secondly, the lamp units could be separated so as to enlarge their light coverage while storing various objects between the lamp units. Further more, the utensils, cruets, magazines stored between the lamp units could be concealed when the lamp units are joined vertically together.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an expandable pendant lamp, when it is collapsed, according to an embodiment of the present invention

FIG. 2 is a perspective diagram showing the expandable pendant lamp of FIG. 1 when it is expanded.

FIG. 3 is a cross-sectional diagram along the 3-3 line of the expandable pendant lamp of FIG. 1.

FIG. 4 is a cross-sectional diagram showing a portion of the expandable pendant lamp of FIG. 2.

FIG. 5 is a schematic diagram showing the details within the circle numbered 5 of FIG. 4.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

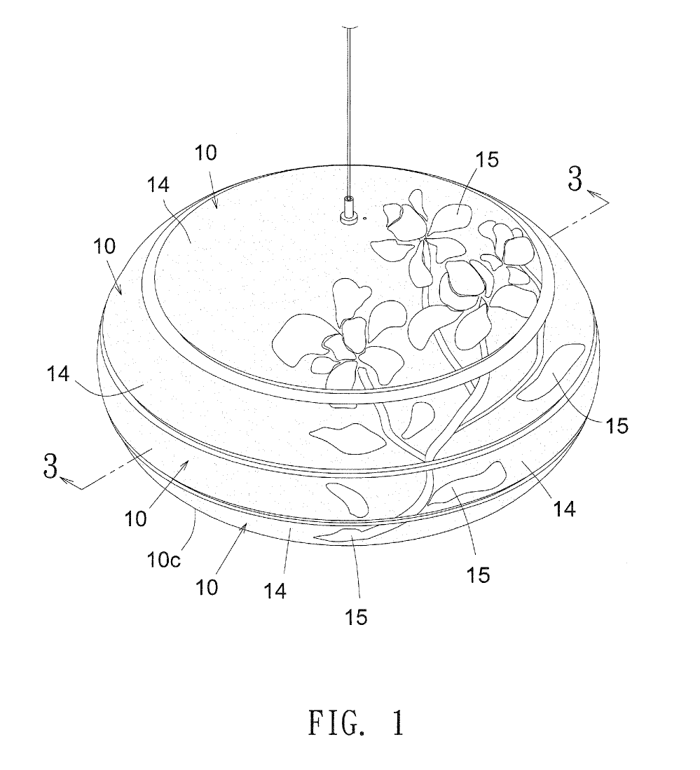

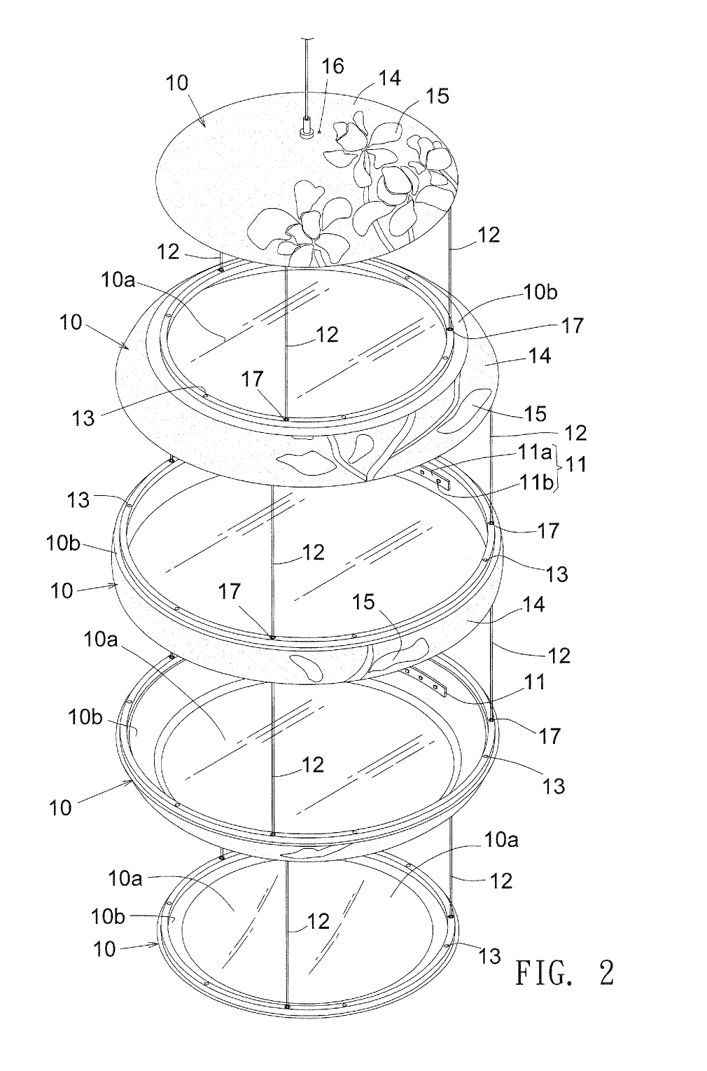

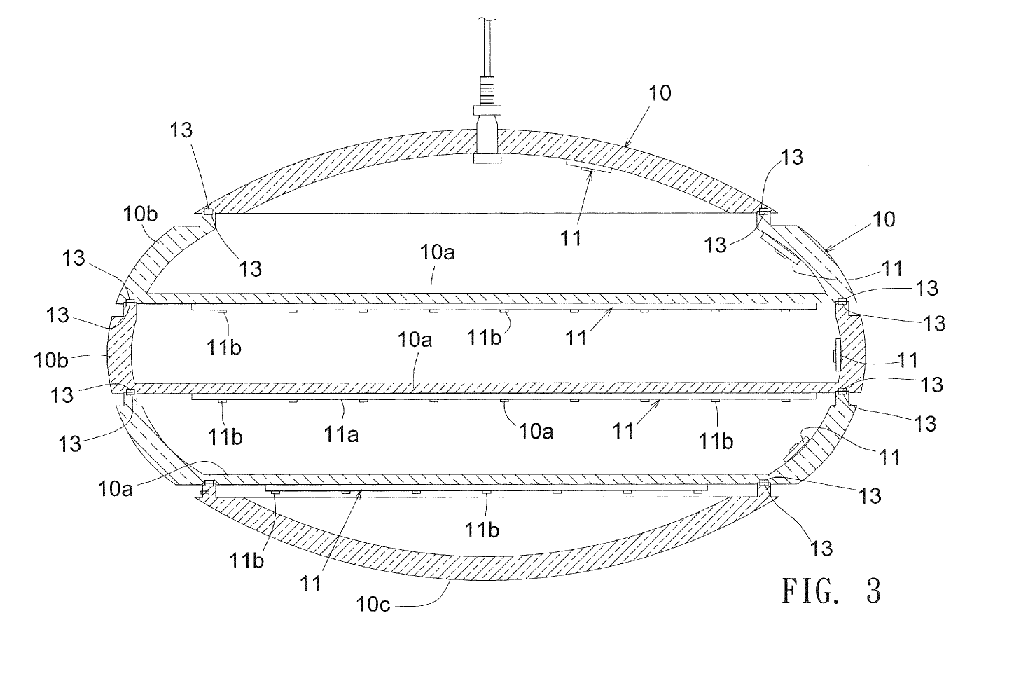

As shown in FIGS. 1 to 4, an expandable pendant lamp according to an embodiment of the present invention contains a number of lamp units 10, each having at least a light generation element 11. The lamp units 10 are vertically stacked and any two adjacent lamp units 10 are connected by a number of flexible linear elements 12. Additionally, for each pair of adjacent lamp units 10, magnetic elements 13 are configured along the interfacing faces of the lamp units 10, respectively. For each pair of corresponding magnetic elements 13 thus configured, their polarities are reversed so that magnetic attraction therebetween would pull the adjacent lamp units 10 together. As described, the expandable pendant lamp, as it is hung from a ceiling, could have its lamp units 10 vertically stacked together. On the other hand, by exerting some force to pull the lamp units 10 apart, the pendant lamp is expanded and the separated lamp units 10 could be used to hold various objects such as utensils and decorators.

The lamp units 10 could be appropriately shaped so that, when they are joined together as described above, the pedant lamp could have a spherical, rectangular, diamond, or conical shape, to mention just a few.

As shown in FIGS. 1 to 3, each lamp unit 10 contains a bottom plate 10a and, along a top rim of the bottom plate 10a, a flange wall 10b is provided. The foregoing magnetic elements 13 are embedded along a top side of the flange wall 10b. The flange walls 10b separate the lamp units 10 and to create storage spaces so that, even when they are joined together, the storage spaces 10a could be used to accommodate various objects.

The foregoing light generation elements 11 could be installed on a top side or a bottom side of the bottom plate 10a, or on an inner side of the flange wall 10b, of each lamp unit 10. Each light generation element 11 contains a number of light emitting diodes (LEDs) lib and a carrier board 11a such as a printed circuit board or a flexible printed circuit board where the LEDs 11b are installed.

Each lamp unit 10 is made of a transparent material so that the light produced from the light generation elements 11 could pass through. Alternatively, a layer of coating 14 is applied to an area 14 of the lamp unit 10's external surface so that the coated area 14 is opaque and the un-coated area 15 reveals a pattern such as flowers. As such, when the light generation elements 11 are turned on, the pattern is vividly illuminated.

Each lamp unit 10 has a through hole 16 allowing a electrical cable L to pass through and to reach the light generation elements 11 on the lamp unit 10 beneath. The present invention does not impose specific requirement on how the light generation elements 11 are installed and wired.

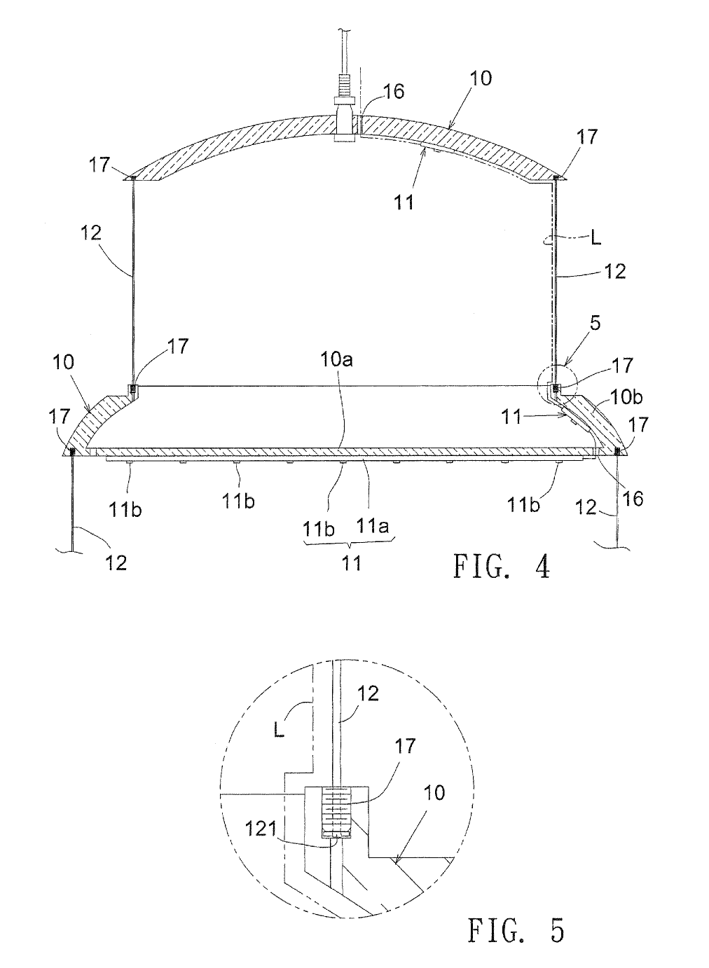

As shown in FIGS. 4 and 5, each flexible linear element 12 has each of its ends running through a positioning screw 17 and forming a locking head 121 beyond the positioning screw 17. The positioning screws 17 are then fixed separately on two adjacent lamp units 10. The present invention does not impose specific requirement on how the flexible linear elements 12 are connected to the adjacent lamp units 10. The flexible linear elements 12 could be a rope, a chain, a steel string, etc. The present invention does not impose specific requirement on the material by which the flexible linear elements 12 are made of.

A bottommost lamp unit 10 could have a transparent bottom area 10c so that the light from the light generation elements 11 could be projected downward to cover a space or a dining table beneath.

The expandable pendant lamp as described has the following advantages. First, the lamp units 10 could be joined together vertically to save space when hung from a ceiling. Secondly, the lamp units 10 could be separated so as to enlarge their light coverage while storing various objects between the lamp units 10. Further more, the utensils, cruets, magazines stored between the lamp units 10 could be concealed when the lamp units 10 are joined vertically together, making the expandable pendant lamp a convenient container.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An expandable pendant lamp, comprising a plurality of lamp unit, each having at least a light generation element, wherein:
said lamp units are vertically stacked and any two adjacent lamp units are connected by a plurality of flexible linear elements;
for each pair of adjacent lamp units, at least a pair of magnetic elements are configured along said adjacent lamp units' interfacing faces, respectively; and
for each pair of corresponding magnetic elements, said corresponding magnetic elements' polarities are reversed so that said adjacent lamp units are pulled by magnetic attraction.

2. The expandable pendant lamp according to claim 1, wherein each lamp unit has a bottom plate; along a top rim of said bottom plate, a flange wall is provided; and said magnetic elements are embedded along a top side of said flange wall.

3. The expandable pendant lamp according to claim 2, wherein said light generation element is installed on a top side of said bottom plate.

4. The expandable pendant lamp according to claim 2, wherein said light generation element is installed on a bottom side of said bottom plate.

5. The expandable pendant lamp according to claim 2, wherein said light generation element is installed on an inner side of said flange wall.

6. The expandable pendant lamp according to claim 1, wherein said light generation element contains a plurality of light emitting diodes and a carrier board where said light emitting diodes are installed.

7. The expandable pendant lamp according to claim 6, wherein said carrier board is a flexible printed circuit board.

8. The expandable pendant lamp according to claim 1, wherein each lamp unit is made of a transparent material.

9. The expandable pendant lamp according to claim 1, wherein each lamp unit is made of a transparent material; and a layer of coating is applied to an area of each lamp unit so that said coated area is opaque.

10. The expandable pendant lamp according to claim 1, wherein each lamp unit has a through hole allowing an electrical cable to pass through and to reach said light generation elements on an adjacent lamp unit beneath.

11. The expandable pendant lamp according to claim 1, wherein each flexible linear element has each of its ends running through a positioning screw and forming a locking head beyond said positioning screw; and said positioning screws are fixed separately on two adjacent lamp units so that said two lamp units are reliably connected by said flexible linear elements.

12. The expandable pendant lamp according to claim 1, wherein a bottommost lamp unit of said lamp units has a transparent bottom area.
